(19) United States
(12) Patent Application Publication
(10) Pub. No.: US 2012/0182065 A1
(43) Pub. Date: Jul. 19, 2012

(54) RESISTIVE DIVIDER CIRCUIT AND VOLTAGE DETECTION CIRCUIT

(76) Inventor: Kazuaki Sano, Chiba-shi (JP)

(21) Appl. No.: 13/345,078

(22) Filed: Jan. 6, 2012

(30) Foreign Application Priority Data
Jan. 17, 2011 (JP) 2011-007272

(51) Int. Cl. G05F 3/02

(52) U.S. Cl. 327/543

(57) ABSTRACT

A resistive divider circuit capable of preventing an increase in trimming error under a particular condition by eliminating the effects of on resistances of switch elements, and a voltage detection circuit of high precision are provided. The resistive divider circuit includes a plurality of resistance elements connected in series, the resistance elements having weighted resistance values, and switch elements connected in parallel with the respective resistance elements, where it is configured such that ratios between the resistance values of the resistance elements and resistance values of the corresponding switch elements in a shorted state are constant.

### RELATED APPLICATIONS

This application claims priority under 35 U.S.C. §119 to Japanese Patent Application No. 2011-007272 filed on Jan. 17, 2011, the entire content of which is hereby incorporated by reference.

### BACKGROUND OF THE INVENTION

1. Field of the Invention

The present invention relates to a resistive divider circuit and a voltage detection circuit which are capable of high-precision setting of an output voltage.

2. Description of the Related Art

Generally, for setting a detection voltage of a voltage detection circuit or an output voltage of a voltage stabilization circuit, a resistive divider circuit is used. Further, for obtaining a high-precision detection voltage or a high-precision output voltage using a resistive divider circuit, it is common to perform trimming in a test process for fine adjustment of resistance ratios in order to adjust the output voltage by restricting the errors due to process variations to within a predetermined margin (see, for example, Patent Document 1).

FIG. 2 shows a conventional example of a voltage detection circuit that includes a resistive divider circuit capable of fine adjustment by trimming. In this example, a resistive divider circuit trimming block 10 has resistors 11 to 15, which are connected in series with each other, and fuse elements 100, which are connected in parallel with the respective resistors 11 to 15.

The resistors 11 to 15 are connected in series, with the resistor 11 having the lowest resistance value of R at the top, which is followed by the resistors 12 to 15 each having the resistance value of R multiplied by the nth power of 2 (where n is a positive integer) arranged in ascending order of n. This enables a resistance having a resistance value of n times the resistance value R to be obtained by fuse trimming.

The resistive divider circuit as shown in FIG. 2 is disadvantageous in that it will suffer trimming errors caused by variations in relative accuracy of the resistors. Moreover, in the trimming using fuse elements, once a fuse element is disconnected, it is unrecoverable. Therefore, it is not possible to perform trimming again based on the output voltage obtained by previous trimming.

As a technique of making up for such disadvantages, Patent Document 1 discloses a resistive divider circuit as shown in FIG. 3. The resistive divider circuit in FIG. 3 includes transistor switches 21 to 25 which replace the fuse elements. Further, the transistor switches 21 to 25 are controlled respectively by clock signals divided by an n-stage frequency division circuit. This allows the resistance value of the resistive divider circuit trimming block 10 to be changed in a stepped manner. When the transistor switches 21 to 25 are controlled in the state where a desired detection voltage has been applied to the resistive divider circuit in advance, an output from a comparison circuit 60 will be inverted at the time when the output voltage of the resistive divider circuit becomes equal to a reference voltage. The ON/OFF states of the respective transistor switches 21 to 25 at that time may be recorded and the transistor switches 21 to 25 may finally be fixed to the ON/OFF states as recorded, whereby the trimming is completed. This circuit is advantageous in that high-precision trimming can be implemented independent of the relative accuracies of the resistors having the resistance values of R multiplied by the nth powers of 2 constituting the resistive divider circuit trimming block 10. This is because the trimming is performed on the basis of an actual output voltage that is obtained by turning on or off the respective transistor switches 21 to 25. Even if the relative accuracies of the resistors are deteriorated, the output voltage of the resistive divider circuit will change accordingly, thereby enabling the trimming to be performed accordingly. In the trimming of the resistive divider circuit shown in FIGS. 3 and 4, an error in resistance value which would cause an error in detection voltage is R at the maximum, because the height of one step is R in the case where the resistance value is changed in a stepped manner in the bleeder resistance circuit. The inverted voltage of the voltage detection circuit may suffer a deviation by an amount corresponding to this step height.

[Patent Document 1] Japanese Patent Application Laid-Open No. 2009-31093

### SUMMARY OF THE INVENTION

In the conventional resistive divider circuit shown in FIGS. 3 and 4, however, when the resistance value of the bleeder resistance circuit is changed in a stepped manner, the step heights will vary, because the on resistance of each transistor switch is not zero. More specifically, the step height will deviate from the original step height of R to a greater degree as there is a greater difference in the number of transistor switches that are controlled to be on between the adjacent two stages.

FIG. 5 is a table indicating the differences in resistance values caused by switch elements in a conventional resistive divider circuit. Listed on the table are: a sum of the on resistance values of the transistor switches under each trimming condition; and a difference in the sums of the on resistance values when the trimming condition is switched to the adjacent trimming condition. Here, the on-resistance value of one transistor switch is represented as “ron”. There occurs a greatest difference in the sums of the on resistance values, i.e. 3ron, when the trimming condition is switched from 15R to 16R. More specifically, the difference in the resistance values at the time of switching from 15R to 16R is calculated, not as: 16R−15R=R, but as: (16R+4ron)−(15R+ron)=(R+3ron), resulting in a step height increased by 3ron. At this time, the trimming error will also increase by an amount corresponding to 3ron. As such, the on resistances of the switches will cause the trimming error to increase under a particular trimming condition.

The table shown in FIG. 5 corresponds to the bleeder resistance circuit having the 5-bit configuration. The maximum value of error caused by the on resistances of the transistor switches will be greater in a bleeder resistance circuit having a 6-bit configuration.

The present invention has been accomplished in view of the foregoing problems, and an object of the present invention is to provide means for preventing an increase in trimming error under a particular trimming condition due to the effects of the on resistances of the transistor switches.

In order to achieve the above-described object, the present invention provides a resistive divider circuit which includes: a plurality of resistance elements connected in series with each other, the resistance elements having weighted resistance values; and switch elements connected in parallel with the resistance elements, respectively; wherein ratios between the resistance values of the resistance elements and resistance values of the corresponding switch elements in a shorted state are constant.

According to the resistive divider circuit of the present invention, the effect of the on resistance of each transistor switch can be eliminated, so that it is possible to prevent an increase in trimming error under a particular condition. This ensures an improved accuracy of a voltage detection circuit.

### BRIEF DESCRIPTION OF THE DRAWINGS

FIG. 1 is a block diagram illustrating a voltage detection circuit having a resistive divider circuit according to an embodiment of the present invention;

FIG. 2 is a block diagram illustrating a voltage detection circuit having a conventional resistive divider circuit;

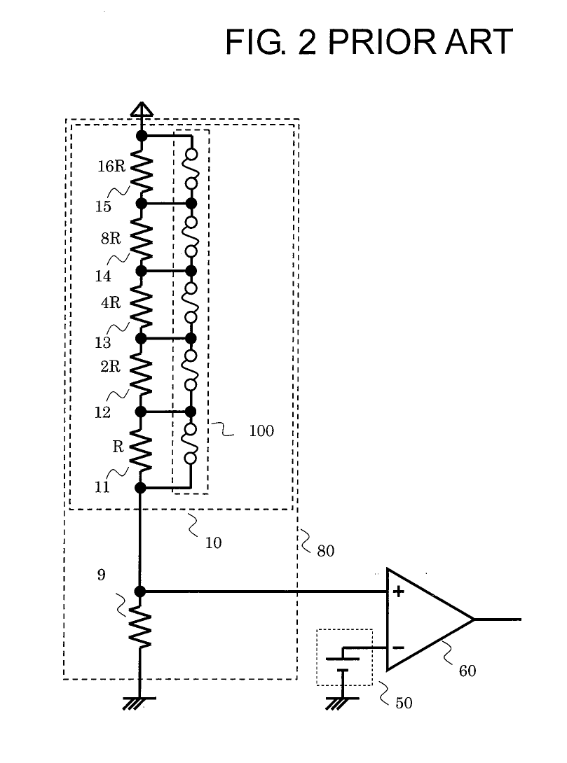

FIG. 3 is a block diagram illustrating another voltage detection circuit having a conventional resistive divider circuit;

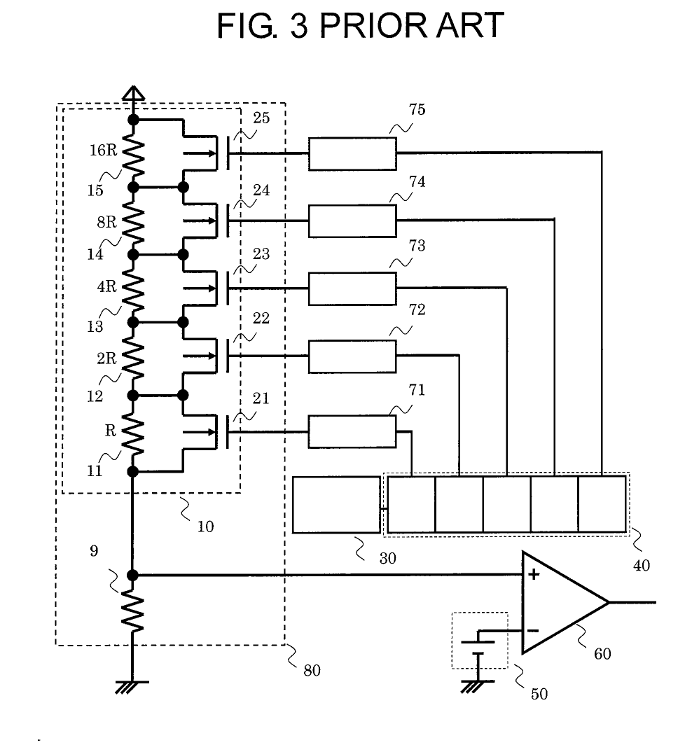

FIG. 4 shows control signals and resistance values of the resistive divider circuit shown in FIG. 3;

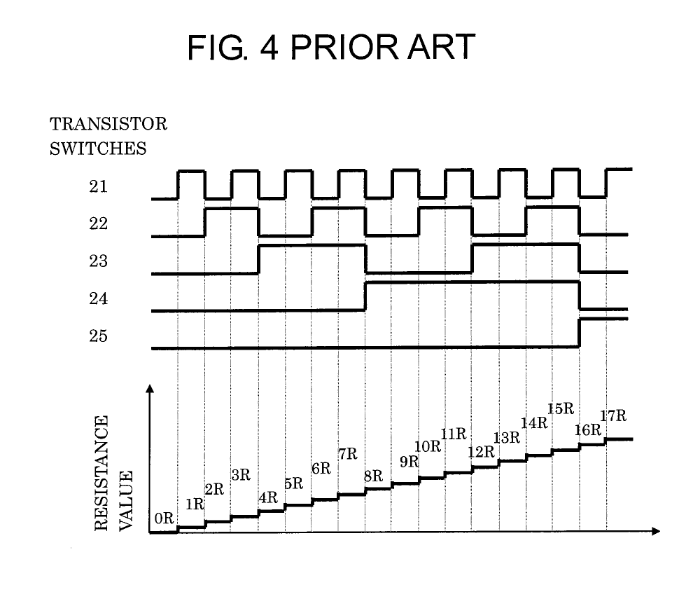

FIG. 5 is a table showing differences in resistance values caused by the switch elements in a conventional resistive divider circuit; and

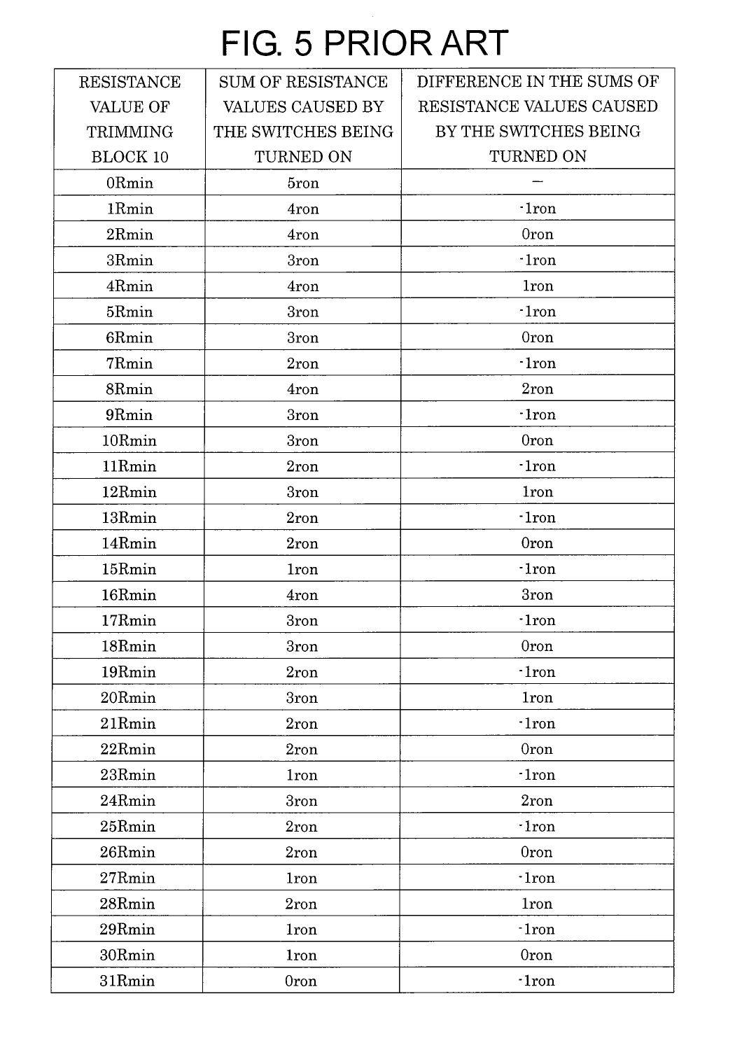

FIG. 6 is a table showing differences in resistance values caused by the switch elements in the resistive divider circuit according to the embodiment of the present invention.

### DETAILED DESCRIPTION OF THE PREFERRED EMBODIMENTS

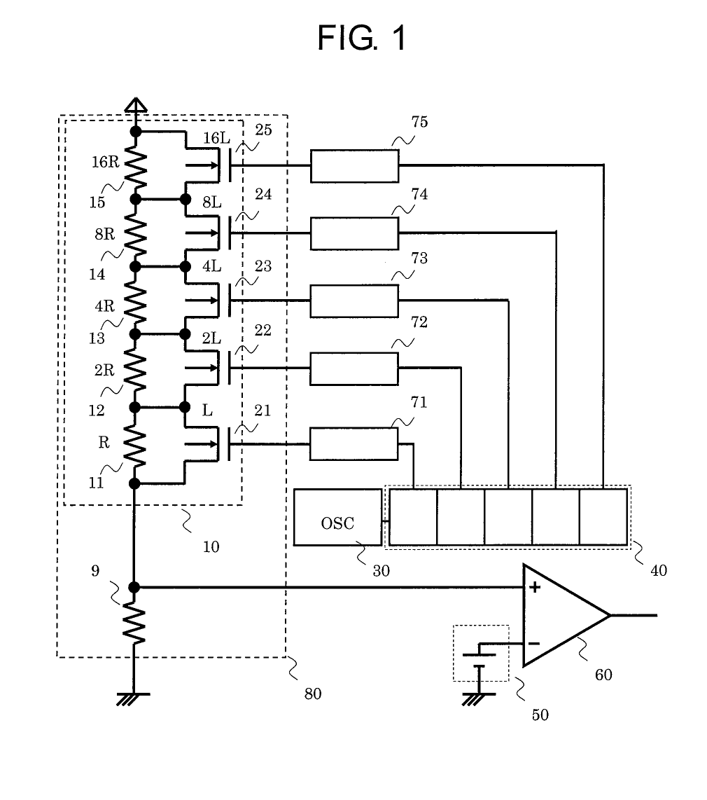

FIG. 1 is a block diagram illustrating a voltage detection circuit having a resistive divider circuit according to an embodiment of the present invention. The resistive divider circuit of the present embodiment has a 5-bit configuration, by way of example.

The voltage detection circuit according to the present embodiment includes an oscillation circuit 30, a frequency division circuit 40, control circuits 71 to 75, a resistive divider circuit 80, a reference voltage circuit 50, and a comparison circuit 60. The resistive divider circuit 80 includes a resistive divider circuit trimming block 10 and a resistor 9.

The resistive divider circuit trimming block 10 has resistors 11 to 15 which are connected in series with each other, and transistor switches 21 to 25 which are connected in parallel with the respective resistors 11 to 15. By way of example, the resistance values of the resistors 11 to 15 are set such that the resistor 11 has the lowest resistance value of R, and the resistors 12 to 15 have the resistance values of R multiplied by the nth powers of 2 (where n is a positive integer) in ascending order of n. More specifically, the resistance values of the resistors 11, 12, and 15 are set to R, 2R, and 16R, respectively.

The channel lengths of the transistor switches 21 to 25 are set as follows. The transistor switch 21 has the shortest channel length value of L, and the transistor switches 22 to 25 have the channel length values of L multiplied by the nth powers of 2 in ascending order of n. More specifically, the transistor switches 21, 22, and 25 have their own resistance values set to ron, 2ron, and 16ron, respectively. As a result, the ratios between the resistance values of the resistors 11 to 15 and those of the transistor switches 21 to 25 connected in parallel with the respective resistors become R/ron constantly.

An operation for changing the resistance value of the resistive divider circuit trimming block 10 in the resistive divider circuit shown in FIG. 1 will now be described.

In order to set the resistance value of the resistive divider circuit trimming block 10 to 15R, the transistor switches 21 to 24 are turned off (open), while the transistor switch 25 is turned on (shorted). The resistance value of the resistive divider circuit trimming block 10 at this time is 15R+16ron, including the on resistance of the transistor switch 25.

Next, in order to set the resistance value of the resistive divider circuit trimming block 10 to 16R, the transistor switches 21 to 24 are turned on (shorted), while the transistor switch 25 is turned off (open). The resistance value of the resistive divider circuit trimming block 10 at this time is 16R+15ron, including the on resistances of the transistor switches 21 to 24.

The difference in the resistance values between these two trimming conditions is represented by the following equation: (16R+15ron)−(15R+16ron)=(R−ron). That is, the difference in the on resistance values of the transistor switches is −ron.

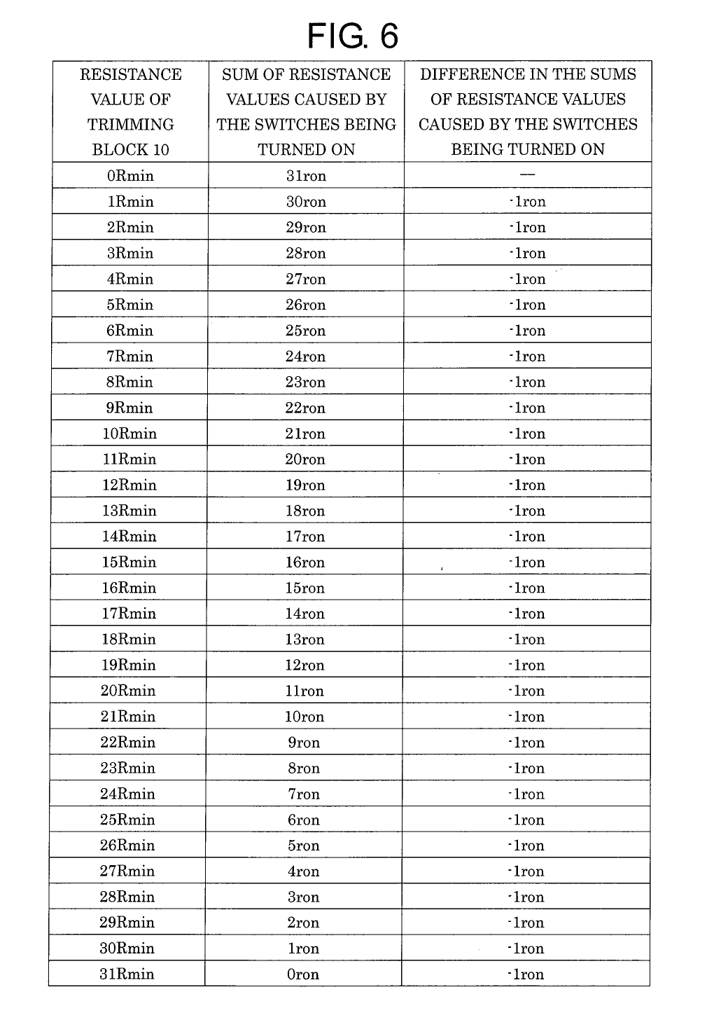

FIG. 6 is a table indicating the differences in the resistance values caused by the switch elements in the resistive divider circuit according to the present embodiment. Listed on the table are: a sum of the on resistance values of the transistor switches; and a difference in the sums of the on resistance values when the trimming condition is switched to the adjacent trimming condition, in the resistive divider circuit in FIG. 1. In this table, the difference in the sums of the on resistance values between the adjacent trimming conditions is −ron for every pair of the conditions. There is no increase in the difference in the resistance values under a particular trimming condition. This means that the on resistances of the transistor switches will not cause an increase in trimming error under a particular condition, so that the trimming can be performed always within a certain error.

In the resistive divider circuit in FIG. 1, the on resistance values of the transistor switches have been adjusted by changing the channel lengths of the transistor switches. Alternatively, the channel widths of the transistor switches may be changed, or the number of transistor switches connected in parallel may be adjusted, to achieve a constant ratio between the resistance values of the resistors in the resistive divider circuit and the on resistance values of the corresponding transistor switches, whereby the similar effects can be obtained.

What is claimed is:

1. A resistive divider circuit comprising:
a plurality of resistance elements connected in series with each other, the resistance elements having weighted resistance values; and
switch elements connected in parallel with the resistance elements, respectively; wherein
ratios between the resistance values of the resistance elements and resistance values of the corresponding switch elements in a shorted state are constant.

2. The resistive divider circuit according to claim 1, wherein the switch element is made up of a MOS transistor.

3. A voltage detection circuit comprising:
the resistive divider circuit according to claim 1;
a control circuit configured to control the switch element; and
a comparison circuit configured to compare an output voltage of the resistive divider circuit with a desired voltage.

4. A voltage detection circuit comprising:
the resistive divider circuit according to claim 2;
a control circuit configured to control the switch element; and
a comparison circuit configured to compare an output voltage of the resistive divider circuit with a desired voltage.
